(19) United States
(12) Patent Application Publication
(10) Pub. No.: US 2026/0211994 A1
(43) Pub. Date: Jul. 23, 2026

(54) WIRELESS CONTROLLED PHYSICAL SECURITY SOLUTION

(71) Applicant: Dell Products L.P., Round Rock, TX (US)

(72) Inventors: Xin Zhi Ma, Shanghai City (CN); Ahmad A.J. Ali, Austin, TX (US)

(21) Appl. No.: 19/034,210

(22) Filed: Jan. 22, 2025

(51) Int. Cl. G06F 21/34

(52) U.S. Cl. CPC G06F 21/34

(57) ABSTRACT

A method for unlocking a secure computing system includes presenting an access key, by a client system, to a wireless communication module of the secure computing system, wherein the access key is generated by an administrative system that is external to the secure computing system. In addition, the method includes authenticating, by the secure computing system, the access key, wherein the authenticating comprises comparing the access key with a pre-stored access key on the secure computing system, wherein the secure computing system is not in communication with the administrative system. Further, the method includes in response to the authentication, initiating an unlocking of a first lock mechanism on the secure computing system, wherein once unlocked, a user may access at least one hardware component located within the secure computing system.

### BACKGROUND

Information Technology (IT) personnel often need to gain physical access to computing systems. However, computing systems often contain sensitive information and/or components that an owner of the computing system may want to restrict access.

### BRIEF DESCRIPTION OF DRAWINGS

Certain embodiments of the disclosure will now be described with reference to the accompanying drawings. However, the accompanying drawings illustrate only certain aspects or implementations of the disclosure by way of example and are not meant to limit the scope of the claims.

FIG. 1 shows a diagram of a system in accordance with one or more embodiments.

FIG. 2 shows a diagram of a secure computing system in accordance with one or more embodiments.

FIG. 3 shows a flowchart of a method for generating access keys for a secure computing system in accordance with one or more embodiments.

FIG. 4 shows a flowchart of a method for presenting an access key to a secure computing system in accordance with one or more embodiments.

FIG. 5 shows a flowchart of a method for presenting an access key to a secure computing system via a communication tunnel in accordance with one or more embodiments.

FIG. 6 shows a flowchart of a method for unlocking a secure computing system in accordance with one or more embodiments.

FIG. 7 shows a diagram of a computing system in accordance with one or more embodiments.

### DETAILED DESCRIPTION

With the rise of edge computing, more and more computing systems are being deployed in unattended environments, posing challenges to their physical security. Hardware components of these systems are commonly housed within chassis (or enclosure), which function as structural enclosures designed to organize and protect the hardware components (e.g., motherboards, storage devices, processors, etc.). These chassis are often designed for ease of access to allow for easy removal and installation of the hardware components. In some cases, chassis may include mechanical locks for intrusion protection. Unfortunately, mechanical locks offer limited protection as they can be easily forced open or bypassed. Further, mechanical locks are often unlockable by physical keys that can be copied and/or stolen. Additionally, traditional chassis do not offer any way to detect if a chassis has been broken into or left open. Thus, traditional chassis cannot prevent malicious actions after the chassis is opened, such as component theft and/or installation of compromised components. Therefore, there is a need for enhanced chassis protection systems to ensure the protection of sensitive information and/or hardware components.

As a result of the limitations of traditional mechanisms to protect hardware within a chassis discussed above, embodiments are directed to a secure computing system. The secure computing system is a secure chassis that governs access to the components housed within the chassis using remotely distributed access keys.

Specific embodiments will now be described with reference to the accompanying figures.

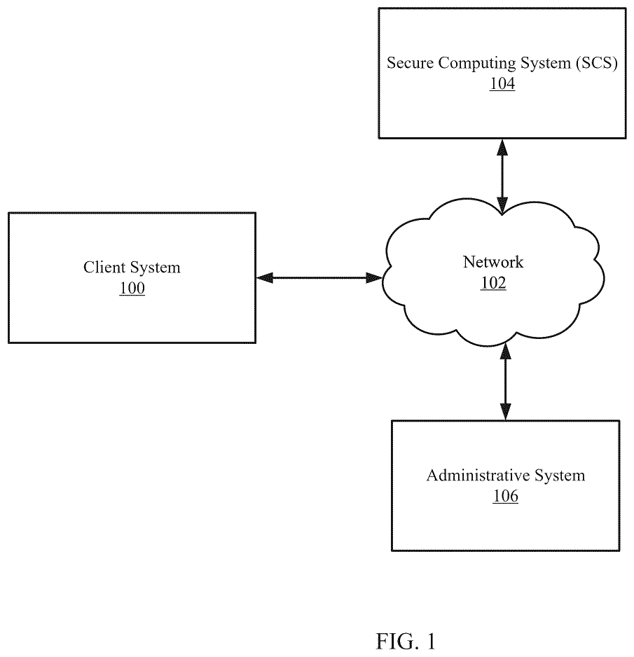

FIG. 1 shows a system in accordance with one or more embodiments. The system may include a client system (100), a network (102), a secure computing system (SCS) (104), and an administrative system (106). The system may include additional, fewer, and/or different components without departing from the scope of the embodiments disclosed herein. Each of these system components is described below.

In one or more embodiments, the client system (100), the SCS (104), and the administrative system (106) may be operatively connected to one another through the network (102) (e.g., a local area network (LAN), a wide area network (WAN) such as the Internet, a mobile network, any other network type, or a combination thereof). Further, the network (102) may encompass various interconnected, network-enabled subcomponents (or systems) (e.g., switches, routers, gateways, etc.) that may facilitate communications between the aforementioned components. Moreover, the client system (100), the SCS (104), and the administrative system (106) may communicate with one another using any combination of wired and/or wireless communication protocols.

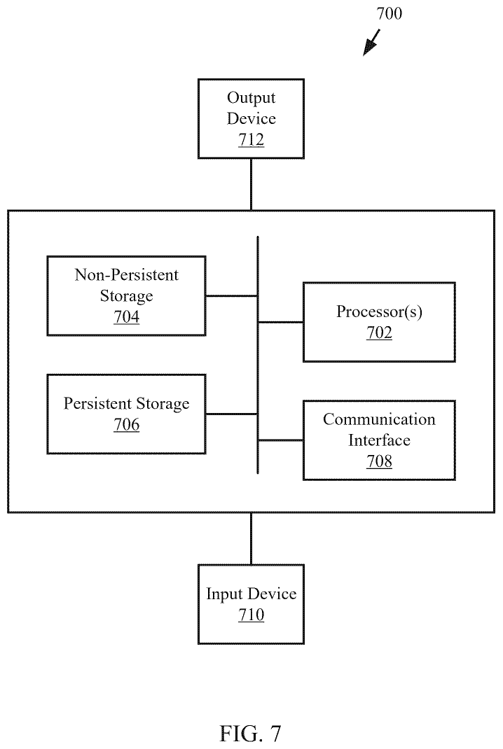

In one or more embodiments, the client system (100), the SCS (104), and the administrative system (106) may be located on a single physical (see e.g., FIG. 7) and/or logical computing system.

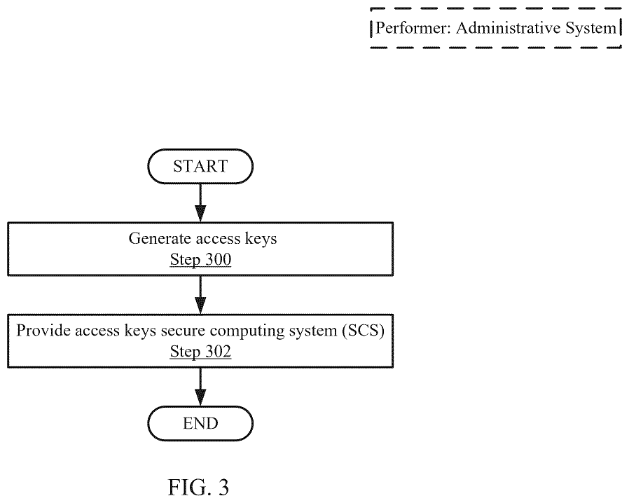

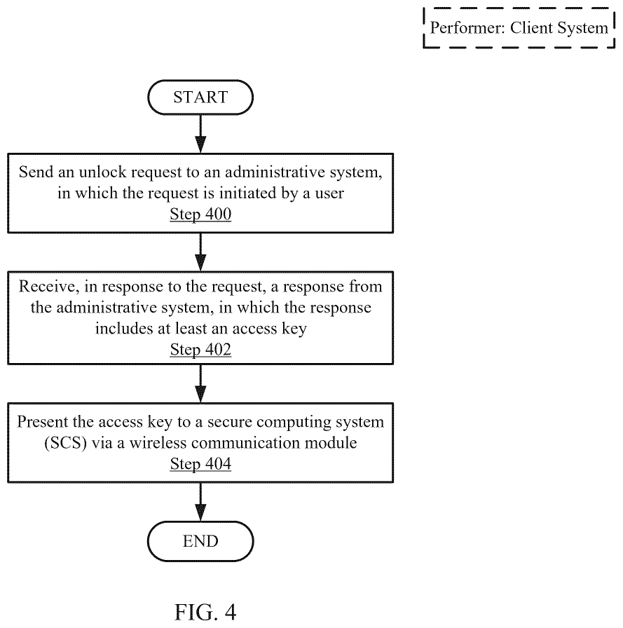

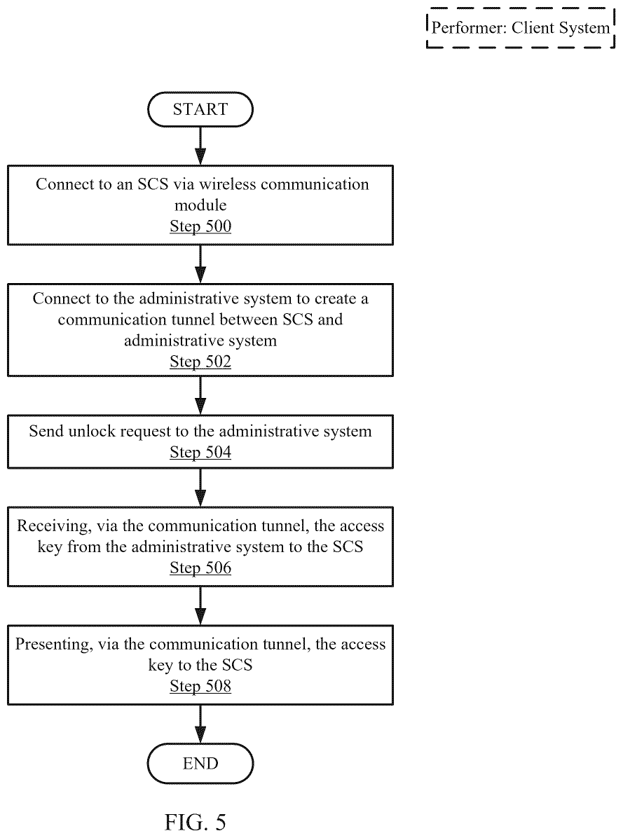

In one or more embodiments, the client system (100) includes the functionality to permit users to interact with the SCS (104). In one or more embodiments, the client system (100) is a wireless-enabled device (e.g., a smart phone) that includes the functionality to transmit data (e.g., an access key) to the SCS (104) using wireless communication protocols and/or mobile networks (i.e., a wireless communication system that enables devices to connect and exchange data across a network of cell towers). In one or more embodiments, the client system (100) may use any wireless communication protocol known in the art or discovered in the future to transmit data including but not limited to, short-range wireless technology (e.g., near-field communication (NFC), Bluetooth, radio-frequency identification (RFID), etc.), long-range wireless technology (e.g., mobile networks), etc. In one or more embodiments, the client system (100) may use any mobile network known in the art or discovered in the future to transmit data including but not limited to second-generation wireless network technology (2G), third-generation wireless network technology (3G), fourth-generation wireless network technology (4G), etc. In one or more embodiments, the client system (100) includes a mobile application that allows users to send requests (e.g., unlock requests) to and receive data (e.g., access keys) from the SCS (104) as described below in FIGS. 4-5. Further, the client system (100) includes functionality to perform at least a portion of the methods shown in FIGS. 3-6. One of ordinary skill will appreciate that the client system (100) may perform other functionalities without departing from the scope of the disclosure.

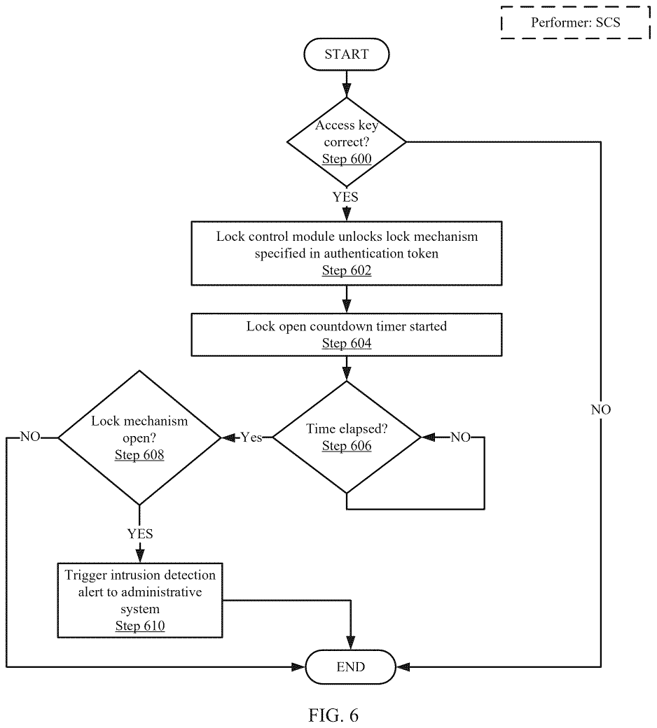

In one or more embodiments, disclosed herein, the client system (100) may be a physical device (see e.g., FIG. 6) such as, e.g., a laptop, a cell phone, a tablet computer, a server, etc. In another embodiment of the disclosure, the client system (100) may be implemented on a virtual device (e.g., a virtual machine executing on one or more physical devices).

In one or more embodiments, the SCS (104) includes the functionality to control access to components within the SCS (104). In one or more embodiments, the SCS (104) includes the functionality to detect and respond to unauthorized access to the components in the SCS (104). In one or more embodiments, disclosed herein, the SCS (104) may be a physical device (see e.g., FIG. 7) such as, e.g., a laptop, a cell phone, a tablet computer, a server, etc. Further, the SCS (104) includes functionality to perform at least a portion of the methods shown in FIGS. 4-6. One of ordinary skill will appreciate that the SCS (104) may perform other functionalities without departing from the scope of the disclosure. While the SCS (104) shown in FIG. 1 may be able to connect to the next, the SCS (104) is not able to directly connect or otherwise interact with the administrative system (106); rather, the SCS (104) may, as discussed below, interact with the administrative system (104) via the client system (100).

In one or more embodiments, the administrative system (106) includes the functionality to generate access keys in response to receiving user input (i.e., unlock requests). In one or more embodiments, the access key may refer to a unique string of characters and/or cryptographic variables that the user presents to the SCS (104) to gain access to the components within the SCS (104). Further, the administrative system (106) includes functionality to perform at least a portion of the methods shown in FIGS. 3-6. One of ordinary skill will appreciate that the administrative system (106) may perform other functionalities without departing from the scope of the disclosure.

In one or more embodiments disclosed herein, the administrative system (106) may be a physical device (see e.g., FIG. 7) such as, e.g., a laptop, a cell phone, a tablet computer, a server, etc. In another embodiment of the disclosure, the administrative system (106) may be implemented on a virtual device (e.g., a virtual machine executing on one or more physical devices).

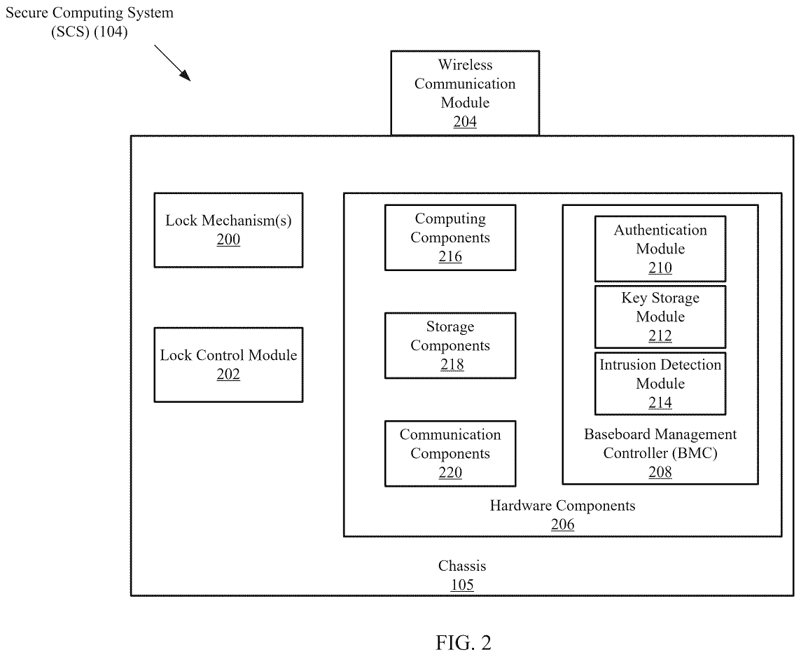

FIG. 2 shows a SCS (e.g., 104 in FIG. 1) in accordance with one or more embodiments. More specifically, in one or more embodiments of the disclosure, the SCS (e.g., 104 in FIG. 1) includes a chassis (105), a lock mechanism (200), a lock control module (202), and a wireless communication module (204). The aforementioned components are used to control physical access to hardware components (206), a baseboard management controller (BMC) (208), an authentication module (210), a key storage module (212), an intrusion detection module (214), computing components (216), storage components (218), communication components (220) or any other components located (or mounted) within the chassis (105). It should be appreciated, that the chassis (105) may be the chassis of a server or any other computing system (e.g., network switches, workstations, desktops, etc.) Each of the aforementioned components may be operably/operatively connected to any of the other aforementioned components via any combination of wired and/or wireless connections. Each of these system components is described below.

In one or more embodiments, the chassis (105) is a physical enclosure in which the hardware components (206) are housed. Though not shown in FIG. 2, the chassis (105) may include a front panel on which the wireless communication module (204) is installed. The front panel is in a locked or unlocked state based on the operation of the lock mechanism(s) (200) and the lock control module (202) (as further described below). The chassis (105) may also have a back panel and a cover (not shown), where the back panel and the cover are in a locked or unlocked state based on the operation of the lock mechanism(s) (200) and the lock control module (202). The front panel, the back panel, and the cover may be individually and collectively referred to as physical access points.

In one or more embodiments, the lock mechanism (200) is a physical component which includes the functionality to control access to the hardware components (206) of the SCS (e.g., 104 in FIG. 1). It should be appreciated, that controlling access to the hardware components (206) may include but is not limited to, locking the physical access points to prevent access to the hardware components (206). In one or more embodiments, the lock mechanism (200) remains in a locked position by default regardless of the SCS's (e.g., 104 in FIG. 1) power state. In one or more embodiments, the lock mechanism (200) may lock if SCS (e.g., 104 in FIG. 1) loses power. In one or more embodiments, the lock mechanism (200) may stay unlocked when the SCS (e.g., 104 in FIG. 1) loses power if the lock mechanism was authorized to be unlocked by the SCS (e.g., 104 in FIG. 1) prior to the SCS (e.g., 104 in FIG. 1) losing power. In one or more embodiments, the SCS (e.g., 104 in FIG. 1) may include more than one lock mechanism (200) (e.g., one lock mechanism for each of the physical access points). It should be further appreciated, that the lock mechanism (200) may include any electromechanical lock (e.g., motorized screws), electromagnetic lock, and/or any suitable lock known in the art or discovered in the future. Further, the lock mechanism (200) includes functionality to perform at least a portion of the methods shown in FIGS. 4-6. One of ordinary skill will appreciate that the lock mechanism (200) may perform other functionalities without departing from the scope of the disclosure.

In one or more embodiments, the lock control module (202) includes the functionality to control the lock mechanism (200) (i.e., to send an appropriate electronic signal to lock or unlock the lock mechanism (200)). In one or more embodiments, the lock control module (202) may be configured to communicate with the hardware components (206). Further, the lock control module (202) includes functionality to perform at least a portion of the methods shown in FIGS. 3-6. One of ordinary skill will appreciate that the lock control module (202) may perform other functionalities without departing from the scope of the disclosure.

In one or more embodiments, the wireless communication module (204) includes the functionality to facilitate secure communication and data exchange with the client system over wireless communication protocols. In one or more embodiments, the wireless communication module (204) includes the functionality to receive access keys from client systems. In one or more embodiments, the access keys may refer to unique strings of characters and/or cryptographic variables that the user presents the SCS (e.g., 104 in FIG. 1) via the wireless communication module (204) to gain access to the components within the SCS (e.g., 104 in FIG. 1). However, the wireless communication module (204) is not able to directly communicate with the administrative system (106); rather, such communication is enabled by the client system (100) as discussed below.

Continuing with the discussion of FIG. 2, in one or more embodiments, the wireless communication module (204) may use any wireless communication protocol known in the art or discovered in the future including but not limited to, short-range wireless technology (e.g., near-field communication (NFC), Bluetooth, radio-frequency identification (RFID), etc.), long-range wireless technology (e.g., mobile networks), etc. Further, the wireless communication module (204) includes functionality to perform at least a portion of the methods shown in FIGS. 3-6. One of ordinary skill will appreciate that the wireless communication module (204) may perform other functionalities without departing from the scope of the disclosure.

In one or more embodiments, the hardware components (206) may include any physical component operating within the SCS (e.g., 104 in FIG. 1) including but not limited to the BMC (208), the computing components (216), the storage components (218), and the communication components (220). In one or more embodiments, the hardware components (206) work together to facilitate the overall functionality of the SCS (e.g., 104 in FIG. 1). Further, the hardware components (206) include functionality to perform at least a portion of the method shown in FIG. 3-6. One of ordinary skill will appreciate that the hardware components (206) may perform other functionalities without departing from the scope of the disclosure.

In one or more embodiments, the BMC (208) is a computing device that may include, a processor (not shown), the key storage module (212), the authentication module (210), the intrusion detection module (214), and may be configured to monitor and manage access to the hardware components (206). In one or more embodiments, the BMC (208) may include an audit module (not shown) configured to record all system operations in an audit log (e.g., when and for how long the lock mechanism (200) was opened). A non-limiting example of the BMC (208) is an Integrated Dell® Remote Access Controller (iDRAC). Dell is a registered trademark of Dell, Inc. In one or more embodiments, a microcontroller (MCU), an embedded controller (EC), a BIOS, or any other system controllers may be used in place of the BMC (208). Further, the BMC (208) includes functionality to perform at least a portion of the methods shown in FIGS. 3-6. One of ordinary skill will appreciate that the BMC (208) may perform other functionalities without departing from the scope of the disclosure.

In one or more embodiments, the authentication module (210) includes functionality to determine whether access keys are authentic (i.e., comparing access keys presented to the SCS (e.g., 104 in FIG. 1) via the wireless communication module (204)

with the access keys stored (or pre-stored) in the key storage module (212)). In one or more embodiments, the authentication module (210) may determine whether the access keys are authentic by any means known in the art or discovered in the future. Further, the authentication module (210) includes functionality to perform at least a portion of the methods shown in FIGS. 3-6. One of ordinary skill will appreciate that the authentication module (210) may perform other functionalities without departing from the scope of the

disclosure.

In one or more embodiments, the key storage module (212) includes functionality to store data (e.g., the access keys). The key storage module (212) may utilize volatile storage, non-volatile storage, or any combination thereof. Examples of storage include (but are not limited to): a hard disk drive (HDD), a solid-state drive (SSD), random access memory (RAM), flash memory, a tape drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, and virtualized memory. In one or more embodiments, the key storage module (212) may encrypt the data that it stores. Further, the key storage module (212) includes functionality to perform at least a portion of the method shown in FIG. 3-6. One of ordinary skill will appreciate that the key storage module (212) may perform other functionalities without departing from the scope of the disclosure.

In one or more embodiments, the intrusion detection module (214) includes the functionality to detect unauthorized access to the SCS (e.g., 104 in FIG. 1). In one or more embodiments, the intrusion detection module (214) may monitor access by any means known in the art or discovered in the future including but not limited to, physical means (e.g., a physical sensor on the chassis (105)) and electronic means (e.g., monitoring the status of the hardware components (206)). In one or more embodiments, the intrusion detection module (214) may also monitor unsuccessful unlock attempts. In one or more embodiments, the intrusion detection module (214) may include the functionality to perform intrusion detection measures when unauthorized access is detected. In one or more embodiments, the intrusion detection module (214) may continuously monitor the SCS (e.g., 104 in FIG. 1). Further, the intrusion detection module (214) includes functionality to perform at least a portion of the methods shown in FIGS. 3-6. One of ordinary skill will appreciate that the intrusion detection module (214) may perform other functionalities without departing from the scope of the disclosure.

The computing components, the storage components, and the communication components are used to perform computing tasks that are typically performed by servers (e.g., data processing, data analytics, model training, website hosting, etc.). In addition, one or more of the aforementioned components may include functionality to perform some or all of the methods described herein.

In one or more embodiments, the computing components (216) include any components often found in a computer (e.g., processors, graphic processing units (GPUs), input/output controllers, network interfaces, etc.) that contribute to the functionality of the SCS (e.g., 104 in FIG. 1). Further, the computing components (216) include functionality to perform at least a portion of the methods shown in FIGS. 3-6. One of ordinary skill will appreciate that the computing components (216) may perform other functionalities without departing from the scope of the disclosure.

In one or more embodiments, the storage components (218) include functionality to store data. The storage components (218) may utilize volatile storage, non-volatile storage, or any combination thereof. Examples of storage include (but are not limited to):
a hard disk drive (HDD), a solid-state drive (SSD), random access memory (RAM), flash memory, a tape drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, and virtualized memory. Further, the storage components (218) include functionality to perform at least a portion of the method shown in FIG. 3-6. One of ordinary skill will appreciate that the storage components (218) may perform other functionalities without departing from the scope of the disclosure.

In one or more embodiments, the communication components (220) include any computer hardware capable of facilitating data transfer between devices and/or networks (e.g., 102 in FIG. 1); however, the communication components are unable to facilitate interaction between the SCS (104) and the administrative system (106). It should be appreciated, that this may allow for remote control and monitoring of the SCS (e.g., 104 in FIG. 1). Further, the communication components (220) include functionality to perform at least a portion of the methods shown in FIG. 3-6. One of ordinary skill will appreciate that the communication components (220) may perform other functionalities without departing from the scope of the disclosure.

Turning to FIG. 3, FIG. 3 shows a method for generating access keys for a SCS (e.g., 104 in FIG. 1) in accordance with one or more embodiments. The method may be performed by, for example, an administrative system (e.g., 106 in FIG. 1). Other components in the system may perform this method without departing from the disclosure.

While the various steps in the flowchart shown in FIG. 3 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 300, the administrative system (e.g., 106 in FIG. 1) generates at least one access key. In one or more embodiments, the at least one access key may be generated by any means known in the art or discovered in the future. In one or more embodiments, the at least one access key may refer to a unique string of characters and/or cryptographic variables. In one or more embodiments, the at least one access key may be presented to a wireless communication module (e.g., 204 in FIG. 2) to gain access to hardware components (e.g., 206 in FIG. 2) within an SCS (e.g., 104 in FIG. 1) by unlocking at least one lock mechanism (e.g., 200 in FIG. 2). In one or more embodiments, the at least one access key is transmittable via any wireless communication protocol known in the art or discovered in the future including but not limited to short-range wireless technology (e.g., near-field communication (NFC), Bluetooth, radio-frequency identification (RFID), etc.), long-range wireless technology (e.g., mobile networks), etc. In one or more embodiments, the at least one access key may be a one-time use access key (i.e., once the at least one access key is presented to the SCS (e.g., 104 in FIG. 1) it cannot be used again). In one or more embodiments, the at least one access key includes a times-based restriction (e.g., the lock mechanism (e.g., 200 in FIG. 2) may remain unlocked for only two hours after it is unlocked by the at least one access key). In one or more embodiments, the at least one access key may remain valid for a limited time (e.g., the at least one access key must be used within one day of a user receiving it before it becomes invalid).

In step 302, the administrative system (e.g., 106 in FIG. 1) provides the at least one access key to the SCS (e.g., 104 in FIG. 1), where the SCS subsequently stores the access key(s). In one or more embodiments, the at least one access key may be provided to the SCS (e.g., 104 in FIG. 1) by any means known in the art or discovered in the future. In one or more embodiments, the at least one access key is provided to (or otherwise pre-stored on) the SCS (e.g., 104 in FIG. 1) before the SCS (e.g., 104 in FIG. 1) is deployed in its operational environment. In one or more embodiments, once the SCS (e.g., 104 in FIG. 1) is deployed, the administrative system (e.g., 106 in FIG. 1) cannot communicate with the SCS (e.g., 104 in FIG. 1). In one or more embodiments, once the SCS (e.g., 104 in FIG. 1) receives the at least one access key, it stores the at least one access key in a key storage module (e.g., 212 in FIG. 2).

In one or more embodiments, the method ends following step 302.

While the method shown in FIG. 3 corresponds to a method for pre-storing access keys in the SCS prior to deploying the SCS to an operational environment (e.g., a client site), once the SCS has been deployed, any known or later discovered mechanism may be used to upload new access keys to the SCS.

In one or more embodiments, FIGS. 4-6 occur after the SCS (e.g., 104 in FIG. 1) has been deployed in its operational environment.

Turning to FIG. 4, FIG. 4 shows a method for presenting an access key to a SCS (e.g., 104 in FIG. 1) in accordance with one or more embodiments of the disclosure. The method may be performed by, for example, a client system (e.g., 100, FIG. 1). Other components in the system may perform this method without departing from the disclosure.

While the various steps in the flowchart shown in FIG. 4 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 400, a user via the client system (e.g., 100 in FIG. 1) sends an unlock request to an administrative system (e.g., 106 in FIG. 1). In one or more embodiments, the user may prompt the unlock request using a mobile application residing on the client system (e.g., 100 in FIG. 1). In one or more embodiments, the mobile application allows the user to select which hardware components (e.g., 206 in FIG. 2) of a SCS (e.g., 104 in FIG. 1) that the user would like to gain access to (i.e., unlock). In one or more embodiments, the client system (e.g., 100 in FIG. 1) sends the unlock request to the administrative system (e.g., 106 in FIG. 1) via a mobile network (i.e., a wireless communication system that enables devices to connect and exchange data across a network of cell towers). In one or more embodiments, the unlock request may include information related to which portion(s) of the SCS (e.g., 104 in FIG. 1) that the user would like to gain access to and for how long (e.g., unlock the front panel of the chassis (e.g., 105 in FIG. 2) for 30 minutes). Further, in one or more embodiments, the unlock request may include the user's identity and/or why they would like to gain access to the SCS (e.g., 104 in FIG. 1), for example, to perform maintenance on the hardware components (e.g., 206 in FIG. 2). It should be appreciated, that the administrative system (e.g., 106 in FIG. 1) cannot directly communicate with the SCS (e.g., 104 in FIG. 1). In one or more embodiments, the user may send the request is the client system (e.g., 100 in FIG. 1) by any means known in the art or discovered in the future.

In step 402, the client system (e.g., 100 in FIG. 1) receives an access key from the administrative system (e.g., 106 in FIG. 1). In one or more embodiments, the client system (e.g., 100 in FIG. 1) receives the access key from the administrative system (e.g., 106 in FIG. 1) via a mobile network. In one or more embodiments, the access key may refer to a unique string of characters and/or cryptographic variables that the user presents to the SCS (e.g., 104 in FIG. 1) to gain access to the hardware components (e.g., 206 in FIG. 2) within the SCS (e.g., 104 in FIG. 1). In one or more embodiments, the access key may be generated by any means known in the art or discovered in the future. In one or more embodiments, the access key may be presented in a physical form (e.g., a key fob) or digitally (e.g., a digital key sent to a wireless device). In one or more embodiments, the access key is accessible by the user digitally via the GUI of the mobile application. In one or more embodiments, the client system (e.g., 100 in FIG. 1) may notify the user, via the GUI of the mobile application, when the client system (e.g., 100 in FIG. 1) has received the access key. In one or more embodiments, the administrative system (e.g., 106 in FIG. 1) may notify the user, via the GUI, of the hardware components (e.g., 206 in FIG. 2) the access key grants access, and the duration of the access. In one or more embodiments, there may be a discrepancy between what is requested by the user and what is granted in the access key based upon security policies. For example, the user may request access to components A, B, and C, but the access key may only unlock the lock mechanism(s) (e.g., 200 in FIG. 2) that grant access to components A and B because component C contains sensitive data that the user does not have authorization to access. In one or more embodiments, the administrative system (e.g., 106 in FIG. 1) may alter which hardware components (e.g., 206 in FIG. 2) the access key grants access and the duration of the access after sending the access key to the client system (e.g., 100 in FIG. 1).

In step 404, the user presents the access key (or access keys) to the SCS (e.g., 104 in FIG. 1) via a wireless communication module (e.g., 204 in FIG. 2). In one or more embodiments, the user may present the access key (or access keys) to the wireless communication module (e.g., 204 in FIG. 2) using any wireless communication protocol known in the art or discovered in the future including but not limited to short-range wireless technology (e.g., near-field communication (NFC), Bluetooth, radio-frequency identification (RFID), etc.), long-range wireless technology (e.g., mobile networks), etc.). In one or more embodiments, presenting the access key to the wireless communication module (e.g., 204 in FIG. 2) may include placing the client system near the wireless communication module (e.g., 204 in FIG. 2) thereby enabling data transfer between the wireless communication module (e.g., 204 in FIG. 2) and the client system. In one or more embodiments, if NFC is the wireless protocol used, the access key is transferred via electromagnetic induction when the client system is brought near the wireless communication module (e.g., 204 in FIG. 2).

In one or more embodiments, the method may end following step 404.

Following FIG. 4, a user may attempt to obtain access to the SCS (e.g., 104 in FIG. 1) using the access key via the method in FIG. 6.

Turning to FIG. 5, FIG. 5 shows a method presenting an access key to a SCS (e.g., 104 in FIG. 1) via a communication tunnel in accordance with one or more embodiments. The method may be performed by, for example, the client system (e.g., 100, FIG. 1). Other components in the system may perform this method without departing from the disclosure.

While the various steps in the flowchart shown in FIG. 5 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 500, the client system (e.g., 100, FIG. 1) connects to a SCS (e.g., 104 in FIG. 1) via a wireless communication module (e.g., 204 in FIG. 2). In one or more embodiments, a user may use a mobile application to connect the client system (e.g., 100 in FIG. 1) to the SCS (e.g., 104 in FIG. 1). In one or more embodiments, the mobile application resides on the client system (e.g., 100 in FIG. 1). In one or more embodiments, the mobile application may include a graphical user interface (GUI) that enables the user to select a device or system to which the client system (e.g., 100 in FIG. 1) should be connected. In one or more embodiments, the mobile application may notify the user, via the GUI, when the client system (e.g., 100 in FIG. 1) has successfully connected to the SCS (e.g., 104 in FIG. 1). In one more embodiment, the client system (e.g., 104 in FIG. 1) may connect to the wireless communication module (e.g., 204 in FIG. 2) using any wireless communication protocol known in the art or discovered in the future including but not limited to short-range wireless technology (e.g., near-field communication (NFC), Bluetooth, radio-frequency identification (RFID), etc.), long-range wireless technology (e.g., mobile networks), etc. In one or more embodiments, the client system (e.g., 100 in FIG. 1) may connect to the SCS (e.g., 104 in FIG. 1) via a wired connection.

In step 502, the client system (e.g., 100, FIG. 1) connects to an administrative system (e.g., 106 in FIG. 1) via a mobile network (i.e., a wireless communication system that enables devices to connect and exchange data across a network of cell towers). In one or more embodiments, the user may use the mobile application to connect the client system (e.g., 100 in FIG. 1) to the administrative system (e.g., 106 in FIG. 1). In one or more embodiments, the mobile application may notify the user, via the GUI, when the client system (e.g., 100 in FIG. 1) has successfully connected to the administrative system (e.g., 106 in FIG. 1). In one or more embodiments, the connection between the client system (e.g., 100 in FIG. 1) and the SCS (e.g., 104 in FIG. 1) and the connection between the client system (e.g., 100 in FIG. 1) and the administrative system (e.g., 106 in FIG. 1) results in a communication tunnel between the SCS (e.g., 104 in FIG. 1) and the administrative system (e.g., 106 in FIG. 1). It should be appreciated, that the administrative system (e.g., 106 in FIG. 1) cannot communicate with the SCS (e.g., 104 in FIG. 1) without using the communication tunnel. In one or more embodiments, the communication tunnel allows the SCS (e.g., 104 in FIG. 1) and the administrative system (e.g., 106 in FIG. 1) to relay data (e.g., access keys, unlock commands, etc.) between one another without requiring the client system (e.g., 100 in FIG. 1) to manage or control the data. Said another way, once the communication tunnel is established the client system merely acts as a communication relay between the SCS and the administrative system.

In step 504, the user via a client system (e.g., 100 in FIG. 1) sends an unlock request to the administrative system (e.g., 106 in FIG. 1). In one or more embodiments, the user may prompt the unlock request using the mobile application executing on the client system (e.g., 100 in FIG. 1). In one or more embodiments, the mobile application allows the user to select which hardware components (e.g., 206 in FIG. 2) of the SCS (e.g., 104 in FIG. 1) that the user would like to gain access to (i.e., unlock). In one or more embodiments, the client system (e.g., 100 in FIG. 1) sends the unlock request to the administrative system (e.g., 106 in FIG. 1) via the mobile network. In one or more embodiments, the unlock request may include information related to which portion(s) of the SCS (e.g., 104 in FIG. 1) that the user would like to gain access to and for how long (e.g., unlock the front panel of the chassis (e.g., 105 in FIG. 2) for 30 minutes). Further, in one or more embodiments, the unlock request may include the user's identity and/or why they would like to gain access to the SCS (e.g., 104 in FIG. 1), for example, to perform maintenance on hardware components (e.g., 206 in FIG. 2). In one or more embodiments, the user may send the request by any means known in the art or discovered in the future.

In step 506, the client system (e.g., 100 in FIG. 1) receives an access key from the administrative system (e.g., 106 in FIG. 1). In one or more embodiments, the access key is passed directly from the administrative system (e.g., 106 in FIG. 1) through the client system (e.g., 100 in FIG. 1) to the SCS (e.g., 104 in FIG. 1) via the communication tunnel. In one or more embodiments, when the communication tunnel is being used, the client system (e.g., 100 in FIG. 1) does not have access to or interacts with the access key but functions solely as an intermediary between the SCS (e.g., 104 in FIG. 1) and the administrative system (e.g., 106 in FIG. 1). In one or more embodiments, the administrative system (e.g., 106 in FIG. 1) may notify the user, via the GUI, of the hardware components (e.g., 206 in FIG. 2) the access key grants access and the duration of the access. In one or more embodiments, there may be a discrepancy between what is requested by the user and what is granted in the access key based upon security policies. For example, the user may request access to components A, B, and C, but the access key may only unlock the lock mechanism(s) (e.g., 200 in FIG. 2) that grant access to components A and B because component C contains sensitive data that the user does not have authorization to access. In one or more embodiments, the administrative system (e.g., 106 in FIG. 1) may alter which hardware components (e.g., 206 in FIG. 2) the access key grants access to and the duration of the access after sending the access key to the client system (e.g., 100 in FIG. 1).

In step 508, the client system (e.g., 100 in FIG. 1) presents the access key (or access keys) to the SCS (e.g., 104 in FIG. 1). In one or more embodiments, the client system (e.g., 100 in FIG. 1) presents the access key(s) to the SCS (e.g., 104 in FIG. 1) via the communication tunnel (i.e., the access key passes directly from the administrative system (e.g., 106 in FIG. 1) to the SCS (e.g., 104 in FIG. 1) without the client system's (e.g., 100 in FIG. 1) interference). In one or more embodiments, the mobile application, via the GUI, notifies the user when the access key has been presented to the SCS (e.g., 104 in FIG. 1).

In one or more embodiments, the method may end following step 508.

Following FIG. 5, a user may attempt to obtain access to the SCS (e.g., 104 in FIG. 1) using the access key via the method in FIG. 6.

While FIGS. 4 and 5 show methods for obtaining and presenting the access key(s) to the SCS using a client system, the access keys may also be stored on a key fob (or similar device). In this scenario, the access key may be presented to the SCS by placing the key fob in close proximity to the wireless communication module.

Turning to FIG. 6, FIG. 6 shows a method for unlocking a SCS (e.g., 104 in FIG. 1) in accordance with one or more embodiments. The method may be performed by, for example, the SCS (e.g., 104, FIG. 1). Other components in the system may perform this method without departing from the disclosure.

While the various steps in the flowchart shown in FIG. 6 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 600, an authentication module (e.g., 210 in FIG. 2) determines whether an access key is authentic. In one or more embodiments, the access key corresponds to the access key from FIGS. 4 and 5 that is presented to the SCS (or presented to the SCS via a key fob). In one or more embodiments, the access key may refer to a unique string of characters and/or cryptographic variables that a user presents to the SCS (e.g., 104 in FIG. 1) to gain access to hardware components (e.g., 206 in FIG. 2) in the SCS (e.g., 104 in FIG. 1). In one or more embodiments, the authentication module (e.g., 210 in FIG. 2) determines whether the access key is authentic by comparing it with previous access keys stored in a key storage module (e.g., 212 in FIG. 2) of the SCS (e.g., 104 in FIG. 1). In one or more embodiments, if the access key matches an access key in the key storage module (e.g., 212 in FIG. 2), then the access key is authentic. In one or more embodiments, the authentication module (e.g., 210 in FIG. 2) may use any means known in the art or discovered in the future to determine whether the access key is authentic. Accordingly, if the result of this determination is YES, the method proceeds to step 604. If the result of the determination is NO, the method may end.

As a result of the authentication module (e.g., 210 in FIG. 2) determining that the access key is authentic, in step 602, a lock control module (e.g., 202 in FIG. 2) unlocks a lock mechanism (e.g., 200 in FIG. 2). In one or more embodiments, the lock mechanism(s) (e.g., 200 in FIG. 2) that is unlocked may correspond to the lock mechanism(s) specified by the access key. In one or more embodiments, in response to unlocking the lock mechanism (e.g., 200 in FIG. 2) an intrusion detection module (e.g., 214 in FIG. 2) may generate and store a corresponding audit log entry. In one or more embodiments, the lock control module (e.g., 202 in FIG. 2) may be configured to open up a first lock mechanism (e.g., 200 in FIG. 2) and a second lock mechanism (e.g., 200 in FIG. 2), where after unlocking the first lock mechanism (e.g., 200 in FIG. 2), the second lock mechanism (e.g., 200 in FIG. 2) will only unlock after the first lock mechanism (e.g., 200 in FIG. 2) has been re-locked.

In step 604, the intrusion detection module (e.g., 214 in FIG. 2) begins a countdown in response to the lock mechanism (e.g., 200 in FIG. 2) being unlocked. In one or more embodiments, the length of the countdown may be set by the access key. In one or more embodiments, the length of the countdown may also be set based on many variables including but not limited to, the particular lock mechanism (e.g., 200 in FIG. 2) that the user unlocks, the user's identity, time of day that the lock mechanism (e.g., 200 in FIG. 2) is unlocked, the quantity of lock mechanisms (e.g., 200 in FIG. 2) unlocked, etc. In one or more embodiments, there may be more than one countdown based on the number of lock mechanisms (e.g., 200 in FIG. 1) that are unlocked. In one or more embodiments, the countdown may be canceled by relocking the lock mechanism (e.g., 200 in FIG. 2). In one or more embodiments, the lock mechanism may be relocked by any means known in the art or discovered in the future including but not limited to a physical key, a button on a graphical user interface (GUI) of a mobile application of a client system (e.g., 100 in FIG. 1), etc.

In step 606, the intrusion detection module (e.g., 214 in FIG. 2) determines whether the countdown has ended (i.e., the timer has reached zero). Accordingly, if the result of this determination is YES, the method proceeds to step 608. If the result of the determination is NO, then step 606 is repeated until the result is YES.

In step 608, the intrusion detection module (e.g., 214 in FIG. 2) determines whether the lock mechanism (e.g., 200 in FIG. 2) is open. In one or more embodiments, the intrusion detection module (e.g., 214 in FIG. 2) may make the determination by checking the status of the lock control module (e.g., 202 in FIG. 2). In one or more embodiments, the intrusion detection module (e.g., 214 in FIG. 2) may make the determination by any means known in the art or discovered in the future. Accordingly, if the result of this determination is YES, the method proceeds to step 610. If the result of the determination is NO, then the method may end.

In step 610, the intrusion detection module (e.g., 214 in FIG. 2) triggers intrusion detection measures in response to the countdown expiring. In one or more embodiments, the intrusion detection measures may include at least one of, an on-site alarm, re-locking the lock mechanism (e.g., 200 in FIG. 2), encrypting data from at least one hardware component(s) (e.g., 206 in FIG. 2), deleting data from at least one of the hardware components (e.g., 206 in FIG. 2), backing up data from at least one of the hardware components (e.g., 206 in FIG. 2), shutting down the SCS (e.g., 104 in FIG. 1), notifying an administrative system (e.g., 106 in FIG. 1), locking the user out of the mobile application on the client system (e.g., 100 in FIG. 1), etc.

In one or more embodiments, the lock mechanism (e.g., 200 in FIG. 2) may be unlocked while the SCS (e.g., 104 in FIG. 1) is in a powered-off state. In this scenario, upon a subsequent power-up, the unlock may be reported to the BMC (e.g., 208 in FIG. 2) and the administrative system (e.g., 106 in FIG. 1), and the BMC (e.g., 208 in FIG. 2) may block a system boot pending verification by the administrative system (e.g., 106 in FIG. 1).

In one or more embodiments, the method may end following step 610.

Embodiments of the disclosure may be implemented using computing devices. Turning to FIG. 7, FIG. 7 shows a diagram of a computing device (700) in accordance with one or more embodiments. The computing device (700) may include one or more computer processor(s) (702), non-persistent storage (704) (e.g., volatile memory, such as random access memory (RAM), cache memory), persistent storage (706) (e.g., a hard disk, an optical drive such as a compact disk (CD) drive or digital versatile disk (DVD) drive, a flash memory, etc.), a communication interface (708) (e.g., Bluetooth interface, infrared interface, network interface, optical interface, etc.), input devices (710), output devices (712), and numerous other elements (not shown) and functionalities. Each of these components is described below.

In one embodiment, the computer processor(s) (702) may be an integrated circuit for processing instructions. For example, the computer processor(s) (702) may be one or more cores or micro-cores of a processor. The computing device (700) may also include one or more input devices (710), such as a touchscreen, access keyboard, mouse, microphone, touchpad, electronic pen, or any other type of input device. The communication interface (708) may include an integrated circuit for connecting the computing device (700) to a network (not shown) (e.g., a local area network (LAN), a wide area network (WAN) such as the Internet, mobile network, or any other type of network) and/or to another device, such as another computing device.

In one embodiment, the computing device (700) may include one or more output devices (712), such as a screen (e.g., a liquid crystal display (LCD), a plasma display, touchscreen, cathode ray tube (CRT) monitor, projector, or other display device), a printer, external storage, or any other output device. One or more of the output devices (712) may be the same or different from the input devices (710). The input and output device(s) (710, 712) may be locally or remotely connected to the computer processor(s) (702), non-persistent storage (704), and persistent storage (706). Many diverse types of computing devices exist, and the aforementioned input and output device(s) (710, 712) may take other forms.

The problems discussed above should be understood as being examples of problems solved by embodiments of the disclosure and the disclosure should not be limited to solving the same/similar problems. The disclosed disclosure is broadly applicable to address a range of problems beyond those discussed herein.

In the detailed description of the embodiments of the disclosure above, numerous specific details are set forth in order to provide a more thorough understanding of one or more embodiments of the disclosure. However, it will be apparent to one of ordinary skill in the art that the one or more embodiments of the disclosure may be practiced without these specific details. In other instances, well-known features have not been described in detail to avoid unnecessarily complicating the description.

In the prior description of the figures, any component described with regard to a figure, in various embodiments of the disclosure, may be equivalent to one or more like-named components described with regard to any other figure. For brevity, descriptions of these components are not repeated with regard to each figure. Thus, each and every embodiment of the components of each figure is incorporated by reference and assumed to be optionally present within every other figure having one or more like-named components. Additionally, in accordance with various embodiments of the disclosure, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, throughout this application, elements of figures may be labeled as A to N. As used herein, the aforementioned labeling means that the element may include any number of items and does not require that the element include the same number of elements as any other item labeled as A to N unless otherwise specified. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other physical computer readable storage medium. Specifically, the software instructions may correspond to computer readable program code that, when executed by a processor(s), is configured to perform one or more embodiments described herein.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims below.

What is claimed is:

1. A method for unlocking a secure computing system, the method comprising:
presenting an access key, by a client system, to a wireless communication module of the secure computing system,
wherein the access key is generated by an administrative system that is external to the secure computing system, and
wherein the secure computing system is deployed to a location; and
authenticating, by the secure computing system, the access key,
wherein the authenticating comprises comparing the access key with a pre-stored access key on the secure computing system,
wherein the pre-stored access key is stored on the secure computing system prior to being deployed to the location;
wherein the secure computing system is not in communication with the administrative system; and
in response to the authentication, initiating an unlocking of a first lock mechanism on the secure computing system, wherein once unlocked, a user may access at least one hardware component located within the secure computing system.

2. The method of claim 1, further comprising:
wherein prior to the client system presenting the access key to the wireless communication module:
sending, by the user via the client system, an unlock request to the administrative system; and
receiving, in response to the unlock request, the access key from the administrative system, wherein the user is verified to be authorized to have access to the access key by the administrative system, prior to the client system receiving the access key.

3. The method of claim 1, wherein the first lock mechanism, when locked, secures at least one cover of the secure computing system.

4. The method of claim 1, wherein the first lock mechanism, when locked, secures the at least one hardware component located within a chassis.

5. The method of claim 1, wherein the access key specifies a duration that the first lock mechanism can be unlocked.

6. The method of claim 5, further comprising:
after the unlocking:
making a first determination that the duration has elapsed;
making, in response to the first determination, a second determination that the first lock mechanism is unlocked; and
triggering intrusion detection measures, in response to the second determination.

7. The method of claim 1, further comprising:
in response to the authenticating, initiating an unlocking of a second lock mechanism on the secure computing system, wherein once unlocked, the user may access at least one other hardware component of the secure computing system.

8. The method of claim 1,
wherein the secure computing system comprises a chassis, and
wherein the wireless communication module is mounted on the chassis.

9. The method of claim 1, further comprising:
presenting a second access key, by the client system, to the wireless communication module of the secure computing system, wherein the second access key is generated by the administrative system;
authenticating, by the secure computing system, the second access key; and
in response to the authenticating, initiating an unlocking of a second lock mechanism on the secure computing system, wherein once unlocked, the user may access at least one other hardware component of the secure computing system.

10. The method of claim 1, wherein the access key is presented to the wireless communication module using short-range wireless technology.

11. The method of claim 10, wherein the short-range wireless technology is near field communication (NFC).

12. A method for unlocking a secure computing system, the method comprising:
establishing a communication tunnel between an administrative system and the secure computing system using a client system, wherein the client system connects to the administrative system via a wireless network and wherein the client system connects to the secure computing system via a wireless communication module of the secure computing system;
presenting, using the communication tunnel, an access key from the administrative system to the secure computing system;
authenticating, by the secure computing system, the access key; and
in response to the authentication, initiating an unlocking of a first lock mechanism on the secure computing system, wherein once unlocked, a user may access at least one hardware component located within the secure computing system.

13. The method of claim 12, the method further comprising:
wherein prior to presenting the access key from the administrative system to the secure computing system:
sending, by the user via the client system, an unlock request to the administrative system; and
verifying, by the administrative system, that the user is authorized to have access to the access key.

14. The method of claim 12, wherein the first lock mechanism, when locked, secures at least one cover of the secure computing system.

15. The method of claim 12, wherein the first lock mechanism, when locked, secures the at least one hardware component located within a chassis.

16. The method of claim 12, wherein the access key specifies a duration that the first lock mechanism can be unlocked.

17. The method of claim 16, further comprising:
after the unlocking:
making a first determination that the duration has elapsed;
making, in response to the first determination, a second determination that the first lock mechanism is unlocked; and
triggering intrusion detection measures, in response to the second determination.

18. The method of claim 12, further comprising:
in response to the authenticating, initiating an unlocking of a second lock mechanism on the secure computing system, wherein once unlocked, the user may access at least one other hardware component of the secure computing system.

19. The method of claim 12,
wherein the secure computing system comprises a chassis, and
wherein the wireless communication module is mounted on the chassis.

20. A secure computing system, comprising:
a chassis comprising a wireless communication module;
a lock mechanism;
a lock control module operatively connected to the lock mechanism;
hardware components;
a base board management controller comprising executable instructions, which when executed perform a method, the method comprising:
receiving an access key via the wireless communication module, wherein the access key is generated by an administrative system that is external to the secure computing system;
authenticating the access key without communicating with the administrative system; and
in response to the authentication, instructing the lock control module to initiate an unlocking of the lock mechanism, wherein once unlocked, a user may access at least one of the hardware components.
